(19) United States
(12) Patent Application Publication
(10) Pub. No.: US 2026/0321937 A1
(43) Pub. Date: Oct. 15, 2026

(54) BATTERY INFILTRATION METHOD AND APPARATUS, AND SYSTEM AND STORAGE MEDIUM

(71) Applicants: Tsinghua University, Beijing (CN); Beijing Vfortune New Energy Power Technology Development Co., Ltd., Beijing (CN)

(72) Inventors: Xiangming He, Beijing (CN); Li Wang, Beijing (CN); Hao Cui, Beijing (CN)

(21) Appl. No.: 19/119,069

(22) PCT Filed: Sep. 25, 2023
(86) PCT No.: PCT/CN2023/121184

§ 371 Date: Apr. 7, 2025

(30) Foreign Application Priority Data
Oct. 10, 2022 (CN) 202211234879.7

(51) Int. Cl. H01M 50/609; H01M 4/02; H01M 4/505; H01M 4/525; H01M 10/0587; H01M 10/42; H01M 10/44

(52) U.S. Cl. CPC H01M 50/609; H01M 4/505; H01M 4/525; H01M 10/0587; H01M 10/4235; H01M 10/446; H01M 2004/028

(57) ABSTRACT

The embodiments of the present application provide a battery infiltration method, a device, a system and a storage medium, wherein the method comprises: determining a target voltage based on the battery system parameters of a battery, the target voltage affecting the infiltration performance of an electrolyte on a battery electrode plate; wherein the target voltage is determined from a voltage application range corresponding to the battery system parameters, the voltage application range is determined based on the battery system parameters of the battery; after the electrolyte is injected into the battery and before the electrolyte reacts with the battery electrode plate, generating a voltage application instruction corresponding to the target voltage; wherein the voltage application instruction is used to apply the target voltage to the battery, so as to improve the infiltration performance of the electrolyte on the battery electrode plate. The aembodiments of the present application can conveniently and quickly increase in the battery infiltration speed.

### TECHNICAL FIELD

The embodiments of the present application relate to the field of battery manufacturing, and specifically to a battery infiltration method, an apparatus, a system and a storage medium.

### BACKGROUND

Electrolyte injection is a key process in the production and manufacturing of batteries (such as lithium batteries). It refers to injecting electrolyte into the battery and fully infiltrating the positive and negative electrode materials and the separator of the battery with the electrolyte. Ensuring the effective infiltration of the electrolyte in the battery is of great significance to the safety performance and electrical performance of the battery.

As the application scenarios of batteries continue to increase, the volume energy density and mass energy density of batteries are also gradually increasing, which makes the challenges faced by the battery electrolyte injection process also increase significantly, especially the difficulty of electrolyte infiltration in the battery continues increasing. In this context, how to improve the battery infiltration speed in the battery electrolyte injection process has become a technical problem that technicians in this field need to solve urgently.

### SUMMARY

### Technical Problem

The problem to be solved by the present application is to provide a battery infiltration method, an apparatus, a system and a storage medium, so that the electrolyte can conveniently and quickly infiltrate the battery electrode plate, thereby improving the battery infiltration speed.

### Technical Solution

In the first aspect, the embodiment of the present application provides a battery infiltration method, comprising:
determining a target voltage based on the battery system parameter of a battery, the target voltage affecting the infiltration performance of an electrolyte on the battery electrode plate; wherein the target voltage is determined from a voltage application range corresponding to the battery system parameter, and the voltage application range is determined based on the battery system parameter of the battery;
after the electrolyte is injected into the battery and before the electrolyte reacts with the battery electrode plate, generating a voltage application instruction corresponding to the target voltage; wherein the voltage application instruction is used to apply the target voltage to the battery, so as to improve the infiltration performance of the electrolyte on the battery electrode plate.

Optionally, the battery comprises a first electrode and a second electrode; said generating a voltage application instruction corresponding to the target voltage comprises:
generating a voltage application instruction for applying the target voltage to the first electrode and the second electrode;
wherein the first electrode carries a first charge after the target voltage is applied, and the second electrode carries a second charge after the target voltage is applied; a first ion is attracted by the first electrode with the first charge and moves to the first electrode; a second ion is attracted by the second electrode with the second charge and moves to the second electrode.

Optionally, the first electrode is a positive electrode and the second electrode is a negative electrode; the first charge is a negative charge and the second charge is a positive charge; the first ion is a cation and the second ion is an anion.

Optionally, the representation of the infiltration performance comprises a contact angle;
the smaller the contact angle, the better the infiltration of the electrolyte to the electrode plate or a separator of the battery.

Optionally, said determining the target voltage based on the battery system parameters of the battery comprises:
determining the voltage application range under the battery system parameters according to the relationship between the battery voltage corresponding to the battery system parameters and the battery infiltration degree; selecting the target voltage according to the voltage application range; or
determining the voltage application range corresponding to the battery system parameters of the battery from a preset voltage application range set; selecting the target voltage from the determined voltage application range; the voltage application range set records the voltage application ranges corresponding to multiple battery system parameters, wherein the voltage application range under a battery system parameter is determined based on the relationship between the battery voltage corresponding to this battery system parameter and the battery infiltration degree.

Optionally, the voltage application range corresponding to the battery system parameter of the battery is 0 V to 2 V or −2 V to 0 V; the absolute value of the target voltage is 0.1 V.

Optionally, the target voltage is applied in a manner of a constant voltage or a pulsed voltage.

Optionally, the battery system parameters comprise: ambient temperature of battery electrolyte injection, operating pressure, a battery structure, an electrode plate parameter, an electrolyte parameter, a separator, and an interaction parameter between an electrode plate or a separator and the electrolyte.

Optionally, the battery system parameters are first battery system parameters, the battery structure in the first battery system parameters is a wound-type battery, and the positive electrode plate in the electrode plate parameters is a ternary material of Material NMC622;
wherein, under the first battery system parameters, if the target voltage is not applied to the battery, the time taken for the electrolyte to infiltrate the battery electrode plate in the battery is a first period; if the target voltage is applied to the battery, the time taken for the electrolyte to infiltrate the battery electrode plate in the battery is a second period; the second period is less than the first period.

Optionally, the battery system parameters are second battery system parameters, the battery structure in the second battery system parameters is a laminated battery, and the positive electrode plate in the electrode plate parameters is a material of lithium ferrous phosphate LFP;
under the second battery system parameter, if the target voltage is not applied to the battery, the time taken for the electrolyte to infiltrate the battery electrode plate in the battery is a third period; if the target voltage is applied to the battery, the time taken for the electrolyte to infiltrate the battery electrode plate in the battery is a fourth period;
wherein the fourth period is less than the third period, and the fourth period is less than the second period; the second period is the time taken for the electrolyte to infiltrate the battery electrode plate in the battery when the target voltage is applied to the battery corresponding to the first battery system parameters under the first battery system parameters, the battery structure in the first battery system parameters is a wound-type battery, and the positive electrode plate in the electrode plate parameters is Material NMC622; other parameters of the first battery system parameter are the same as those of the second battery system parameters except for the battery structure and the electrode plate parameters.

In the second aspect, the embodiments of the present application also provide a battery infiltration apparatus, comprising:
a determination module, configured to determine a target voltage based on a battery system parameter of a battery, the target voltage affecting the infiltration performance of an electrolyte on the battery electrode plate; wherein the target voltage is determined from a voltage application range corresponding to the battery system parameter, and the voltage application range is determined based on the battery system parameter of the battery;
a processing module, configured to generate a voltage application instruction corresponding to the target voltage after the electrolyte is injected into the battery and before the electrolyte reacts with the battery electrode plate; the voltage application instruction is used to apply the target voltage to the battery, so as to improve the infiltration performance of the electrolyte on the battery electrode plate.

In the third aspect, the embodiments of the present application also provide a battery infiltration system, which at least comprises a data processing device and a voltage application equipment;
wherein the data processing device is used to determine a target voltage based on a battery system parameter of a battery, the target voltage affecting the infiltration performance of the electrolyte on the battery electrode plate; wherein the target voltage is determined from a voltage application range corresponding to the battery system parameter, and the voltage application range is determined based on the battery system parameter of the battery; after the electrolyte is injected into the battery and before the battery electrode plate of the battery reacts with the electrolyte, a voltage application instruction corresponding to the target voltage is generated;
the voltage application equipment is used to apply the target voltage to the battery under the control of the voltage application instruction, so as to improve the infiltration performance of the electrolyte on the battery electrode plate.

In the fourth aspect, the embodiments of the present application also provide a storage medium, which stores one or more computer executable instructions, and the one or more computer executable instructions are used to execute the battery infiltration method described in the first aspect above.

### Beneficial Effects

Compared with the prior art, the technical solution of the present application has the following advantages:

In the battery infiltration method provided in the embodiments of the present application, based on the determination of the battery system parameters, the target voltage is determined, and the target voltage affects the infiltration performance of the electrolyte on the battery electrode plate; and then after the electrolyte is injected into the battery and before the battery electrode plate of the battery reacts with the electrolyte, a voltage application instruction corresponding to the target voltage is generated; the voltage application instruction is used to apply the target voltage to the battery, so as to improve the infiltration performance of the electrolyte on the battery electrode plate.

It can be seen that the embodiments of the present application can determine the target voltage that affects the infiltration performance of the electrolyte on the battery electrode plate based on the battery system parameters when the battery system parameters of the battery are determined, so that after the electrolyte is injected into the battery and before the battery electrode plate of the battery reacts with the electrolyte, a voltage application instruction corresponding to the target voltage is generated to apply the target voltage to the battery, so as to improve the infiltration performance of the electrolyte on the battery electrode plate. Since the embodiments of the present application can apply the target voltage to the battery based on the voltage application instruction, the infiltration performance of the electrolyte on the battery electrode plate is improved, thus the battery infiltration speed is increased, and it is possible to more conveniently and quickly increase the battery infiltration speed, thereby avoiding the use of a high-temperature oven and a pressurization and vacuum device to increase the battery infiltration speed, which causes problems such as cumbersome implementation processes and high equipment costs.

### BRIEF DESCRIPTION OF THE DRAWINGS

FIG. 1 is an optional schematic view of the battery electrolyte injection process.

FIG. 2 is an optional flow chart of the battery infiltration method provided in an embodiment of the present application.

FIG. 3 is a schematic view of the cross-section of the wound electrode plate core of the battery.

FIG. 4 is a schematic diagram of the surface morphology of different materials of the battery electrode plate and the separator.

FIG. 5 is a schematic view of the contact angle between the electrolyte and different surfaces.

FIG. 6 is a schematic view of the movement state of ions in the electrolyte before and after the target voltage is applied to the battery provided in an embodiment of the present application.

FIG. 7A is a schematic view of the battery infiltration without voltage application provided in an embodiment of the present application.

FIG. 7B is a schematic view of the battery infiltration after voltage application provided in an embodiment of the present application.

FIG. 8A is a schematic view of the battery infiltration without voltage application provided in another embodiment of the present application.

FIG. 8B is a schematic view of the battery infiltration after voltage application provided in another embodiment of the present application.

FIG. 8C is a schematic view of the disassembly comparison of the infiltration on electrode plate before and after voltage application provided in an embodiment of the present application.

FIG. 9 is an optional block diagram of the battery infiltration apparatus provided in an embodiment of the present application.

FIG. 10 is an optional structural schematic view of the battery infiltration system provided in an embodiment of the present application.

### DETAILED DESCRIPTION OF THE PREFERRED EMBODIMENTS

As a substance responsible for conducting ions between the positive and negative electrodes in the battery, the electrolyte plays a very important role in the battery cycle. The interaction between the electrolyte and the various components in the battery (such as the positive electrode, negative electrode, and separator) has important impact on the performance of the battery. In the battery electrolyte injection process, the electrolyte will diffuse into the gap between the battery's electrode plates and separator, the electrodes, and the pores inside the separator within a certain period of time, and such a process is called infiltration. If the electrolyte is not uniformly infiltrated in the battery, it will not only cause uneven battery reaction, but also cause the battery to produce side reactions during long-term charge and discharge cycles, which seriously affects the safety of the battery. Therefore, the effective infiltration of the electrolyte in the battery is of great significance to the safety performance and electrical performance of the battery. However, with the increase in battery energy density, the increase in electrode material density and the thickness etc., the difficulty of electrolyte infiltration continues to increase, and the battery infiltration speed decreases. Based on this, in an optional example, as shown in FIG. 1, an optional schematic diagram of the battery electrolyte injection process, the battery cell is placed in a high-temperature oven (not shown in FIG. 1), and the battery placed in the electrolyte injection chamber is injected with the electrolyte, meanwhile nitrogen N₂ can be used for pressurization. Furthermore, the electrolyte injection chamber is evacuated to a vacuum state using a vacuum generating device, so as to perform battery infiltration and improve the battery infiltration speed. However, the inventors found that for battery cells with larger capacity and electrode materials with poor infiltration performance, such as the material of lithium ferrous phosphate LFP, in the method shown in FIG. 1, the battery is infiltrated using a high-temperature oven and N₂ pressurization and vacuum devices. Although it can improve the battery infiltration speed to a certain extent, the equipment cost is high and the implementation process is also cumbersome.

It can be seen that it is particularly necessary to provide a convenient and fast battery infiltration solution.

In view of this, the embodiments of the present application propose an improved battery infiltration scheme, based on the determination of the battery system parameters, determining the target voltage that affects the infiltration performance of the electrolyte on the battery electrode plate, and then generating a voltage application instruction corresponding to the target voltage after the electrolyte is injected into the battery and before the electrolyte reacts with the battery electrode plate, and the voltage application instruction is used to apply the target voltage to the battery, so as to improve the infiltration performance of the electrolyte on the battery electrode plate, so that the battery infiltration speed is increased. Moreover, based on application of the target voltage, the infiltration performance of the electrolyte on the battery electrode plate is affected, which can more conveniently improve the battery infiltration speed, avoiding the problems of cumbersome implementation processes and high equipment costs caused by using a high-temperature oven and pressurization and vacuum devices to improve the battery infiltration speed.

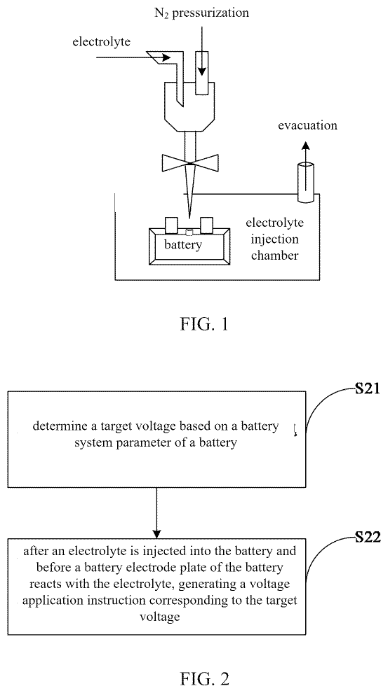

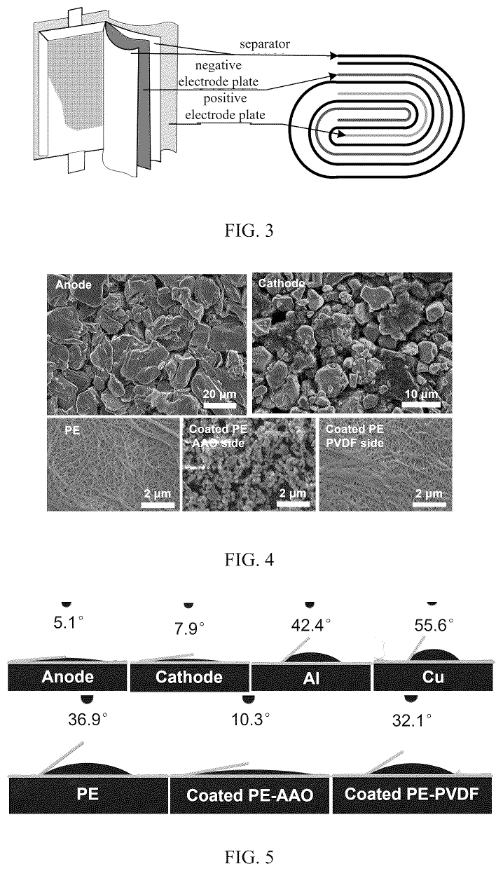

FIG. 2 exemplarily shows an optional flow chart of the battery infiltration method of an embodiment of the present application. As shown in FIG. 2, the following steps may be comprised:
Step S21: determining a target voltage based on the battery system parameters of the battery, and the target voltage affects the infiltration performance of the electrolyte on the battery electrode plate.

Wherein, the battery can be understood as a semi-finished battery. In a specific example, the battery may include a housing and a wound electrode plate core, wherein the wound electrode plate core is arranged inside the housing, and may be formed by winding the electrode plates after the baking process, or may be formed by laminating the electrode plates after the baking process. The present application does not make specific limitations here. The wound electrode plate core comprises a separator, a positive electrode plate and a negative electrode plate. In an optional example, FIG. 3 is a schematic cross-sectional view of the wound electrode plate core of the battery. As shown in FIG. 3, the wound electrode plate core of the battery can be a structure formed by stacking or laminating, and winding the separator, the negative electrode plate, the separator and the positive electrode plate in order. Among them, the battery with a wound electrode plate core formed by laminating and winding is called a wound-type battery, and the battery with a wound electrode plate core formed by stacking and winding is called a stacked-type battery.

The battery system parameters refer to parameter information related to the manufacture of the battery, such as battery structure, electrolyte parameters, etc. During the battery electrolyte injection process, the infiltration process of the electrolyte mainly relies on the capillary action of the electrolyte in the gap of the battery to accomplish the diffusion between the electrodes and the separator. Under different battery system parameters, the degree of reaction between the positive and negative electrode plates or separator of the battery and the electrolyte is different, which also makes the electrolyte have different infiltration performance on the battery electrode plates. Among them, the infiltration performance of the electrolyte on the battery electrode plate refers to the infiltration speed corresponding to the contact between the electrolyte and the battery electrode plate until the electrolyte completely infiltrates the battery electrode plate. Since the electrolyte solution itself is an electrolyte, it contains anions and cations that can move freely. Therefore, the embodiment of the present application applies a voltage to make the electrode surface of the battery carry additional charges, thereby affecting the movement of anions and cations in the electrolyte, so as to improve the infiltration performance of the electrolyte on the electrode surface under the action of electrostatic force. The applied voltage can be called a target voltage. Therefore, based on the battery system parameters of the battery, a target voltage can be determined, and the target voltage affects the infiltration performance of the electrolyte on the battery electrode plate. Wherein, when the battery system parameters of the battery are determined, the target voltage can be determined from the voltage application range corresponding to the battery system parameters, and the voltage application range can be determined based on the battery system parameters of the battery.
Step S22: after the electrolyte is injected into the battery, and before the battery electrode plate of the battery reacts with the electrolyte, a voltage application instruction corresponding to the target voltage is generated.

Wherein, the voltage application instruction is used to apply the target voltage to the battery to improve the infiltration performance of the electrolyte on the battery electrode plate. When the target voltage is applied to the battery according to the voltage application instruction, under the action of the target voltage, the surface of the battery electrode plate of the battery can be charged, so that the anions and cations in the electrolyte are quickly contacted with the battery electrode plate under the influence of the charges on the surface of the battery electrode plate, thereby improving the infiltration performance of the electrolyte on the battery electrode plate, so that the battery electrode plate can be quickly infiltrated by the electrolyte.

In some embodiments, the infiltration performance can be represented by a contact angle. Wherein, the smaller the contact angle, the better the infiltration performance of the electrolyte to the battery electrode plate or the separator. In an optional embodiment, FIG. 4 is a schematic diagram of the surface morphology of different materials of the battery electrode plate and the separator. As shown in FIG. 4, the positive electrode plate (shown as Anode in FIG. 4) and the negative electrode plate (shown as Cathode in FIG. 4) are made of different materials and have different particle sizes; the surface morphologies of the PE separator (shown as PE in the figure) and the PE separator coated with aluminum oxide (AAO) (shown as Coated PE-AAO side in the figure) and the PE separator coated with polyvinylidene fluoride (PVDF) (shown as Coated PE-PVDF side in the figure) are different, but the particle sizes are the same.

Corresponding to the surface morphologies of the battery electrode plate and the separator shown in FIG. 4, there will be a contact angle when the electrolyte contacts the surfaces of the materials of the positive electrode plate, the negative electrode plate and the separator in the battery. Taking the lithium ion electrolyte containing lithium hexafluorophosphate as an example, FIG. 5 exemplarily shows a schematic diagram of the contact angle of different surfaces. As shown in FIG. 5, the gray lines are the liquid tangents of the different material interfaces of the battery and the electrolyte, and the angles formed by the two gray lines represent the contact angles of the electrolyte and the positive electrode material (Anode) (the angle is 5.1°), the contact angle of the electrolyte and the negative electrode material (Cathode) (the angle is 7.9°), the contact angle of the electrolyte and aluminum (Al) (the angle is 42.4°), the contact angle of the electrolyte and copper (Cu) (the angle is 55,6°), the contact angle of the electrolyte and PE separator (PE) (the angle is 36.9°), the contact angle of the electrolyte and PE separator coated with alumina (AAO) (Coated PE-AAO) (the angle is 10.3°) and the contact angle of the electrolyte and PE separator coated with polyvinylidene fluoride (PVDF) (Coated PE-PVDF) (the angle is 32.1°). Referring to FIG. 5, it can be determined that the contact angles of the same electrolyte with the surfaces of different materials are different, among which the contact angles of the positive electrode material and the negative electrode material of the battery are smaller, that is, the positive electrode material and the negative electrode material of the battery are easy to be infiltrated; the infiltration of the battery separator is directly related to its surface material.

It can be understood that when the electrolyte is injected into the battery, the electrolyte first fills the gap inside the battery and contacts the positive and negative electrode current collectors exposed inside the battery to be tested. The anions and cations in the electrolyte adhere to the surfaces of the positive and negative electrode current collectors, and as the infiltration degree increases, the electrolyte can react and contact with the positive and negative electrode plates through the separator of the wound battery core. Moreover, as time goes on, the electrolyte fully infiltrates the positive and negative electrode plates of the battery, and the infiltration state of the battery reaches complete infiltration. Among them, the less time it takes for the battery to reach a complete infiltration state from the initial electrolyte injection, the faster the infiltration speed of the battery, and vice versa, the slower the infiltration speed of the battery. Therefore, it can be determined that the infiltration performance of the electrolyte to the battery electrode plate can reflect the infiltration speed of the battery. Thus, when the infiltration performance of the electrolyte to the battery electrode plate is improved, the infiltration speed of the battery is improved.

It should be noted that in the embodiment of the present application, the best time to generate a voltage application instruction corresponding to the target voltage for applying the target voltage to the battery is after the electrolyte is injected into the battery and before the battery electrode plate of the battery reacts with the electrolyte, thereby avoiding generating a voltage application instruction to apply the target voltage when the electrolyte is injected, so as to affect the reaction of the battery electrode plate with the electrolyte.

It can be seen that in the embodiment of the present application, when the battery system parameters of the battery are determined, the target voltage that affects the infiltration performance of the electrolyte on the battery electrode plate can be determined based on the battery system parameters, thereby applying the target voltage to the battery injected with the electrolyte, so that the electrolyte may fully infiltrate the battery to improve the battery infiltration speed. Moreover, based on application of the target voltage, the infiltration performance of the electrolyte on the battery electrode plate can be affected, which can more conveniently improve the battery infiltration speed, avoiding the problems of cumbersome implementation processes and high equipment costs caused by using a high-temperature oven and pressurization and vacuum devices to improve the battery infiltration speed.

In some embodiments, the battery may include a first electrode and a second electrode, and generating the voltage application instruction corresponding to the target voltage may be generating a voltage application instruction for applying the target voltage to the first electrode and the second electrode. Thus, under the instruction of the voltage application instruction, the target voltage is applied to the first electrode and the second electrode, so that the first electrode carries a first charge after the target voltage is applied, and the second electrode carries a second charge after the target voltage is applied, and the first ion is attracted by the first electrode with the first charge and moves to the first electrode, and the second ion is attracted by the second electrode with the second charge and moves to the second electrode. In an optional example, applying the target voltage to the first electrode and the second electrode may be continuously performed during the battery infiltration process until the infiltration state of the battery accomplishes complete infiltration. In addition, in order to facilitate the control of the battery infiltration degree, the battery infiltration degree of the battery can be detected at the same time of the duration of the battery infiltration process. It should be noted that the above example is only an optional example, and the specific application time of the target voltage is not limited in the embodiment of the present application, and can be set accordingly according to actual needs.

As an optional implementation, the first electrode may be a positive electrode, and the second electrode may be a negative electrode, then the first charge may be a negative charge, the second charge may be a positive charge, the first ion may be a cation, and the second ion may be an anion.

It should be noted that the above example is only an optional implementation. The first electrode may also be a negative electrode, and the second electrode may be a positive electrode. Then the first charge may be a positive charge, the second charge may be a negative charge, the first ion may be an anion, and the second ion may be a cation. The embodiment of the present application does not limit this.

To facilitate understanding of the above contents, take an Al-Cu battery injected with an electrolyte as an example, wherein Cu is used as the positive electrode and Al is used as the negative electrode. FIG. 6 is a schematic view of the movement state of ions in the electrolyte before and after the target voltage is applied to the battery in the embodiment of the present application. As shown in FIG. 6, before the target voltage is applied (left figure), the ions (i.e., anions and cations) of the electrolyte are in a free motion state, and the reaction with the positive electrode plate (the position marked as Copper in the figure) and the negative electrode plate (the position marked as Aluminum in the figure) of the battery is not obvious, and the electrolyte has poor infiltration performance on the battery electrode plate. When the target voltage is applied to the battery (right figure), the positive electrode plate of the battery carries negative charges, and the cations in the electrolyte are attracted by the negative charges and actively move to the positive electrode, so that the cations move to the positive electrode plate within the shortest distance and contact the positive electrode plate, thereby changing the contact angle between the electrolyte and the positive electrode material, thereby improving the infiltration performance of the electrolyte on the positive electrode plate and increasing the infiltration speed. Similarly, the negative electrode plate of the battery carries positive charges, and the anions in the electrolyte are attracted by the positive charge and actively move to the negative electrode, so that the anions move to the negative electrode plate within the shortest distance and contact the negative electrode plate, thereby changing the contact angle between the electrolyte and the negative electrode material, thereby improving the infiltration performance of the electrolyte on the negative electrode plate and increasing the infiltration speed.

In some embodiments, since there is a specific corresponding relationship between the battery voltage and the battery infiltration degree during the battery infiltration process when the battery system parameters are determined, the voltage application range under the battery system parameters can be obtained by empirical analysis, or the voltage application range under the battery system parameters can be obtained by experimental testing. Thus, in the process of determining the target voltage based on the battery system parameters of the battery, as an optional implementation, the voltage application range under the battery system parameters can be determined according to the relationship between the battery voltage corresponding to the battery system parameters and the battery infiltration degree; and then the target voltage is selected according to the voltage application range. As another optional implementation, a voltage application range set can be pre-set, and the voltage application range set records the voltage application ranges corresponding to multiple battery system parameters, wherein the voltage application range under battery system parameters are determined based on the relationship between the battery voltage corresponding to the battery system parameters and the battery infiltration degree, and then the voltage application range corresponding to the battery system parameters of the battery can be determined from the preset voltage application range set, and the target voltage is selected from the determined voltage application range.

In some further embodiments, the voltage application range corresponding to the battery system parameters of the battery may be 0 V to 2 V or −2 V to 0 V. In a preferred example, the voltage application range may be 0.1V~1V or −1V ~−0.1V. The target voltage is selected according to the voltage application range, and in a preferred example, the absolute value of the target voltage is 0.1V, that is, the target voltage is 0.1V or −0.1 V.

In some embodiments, based on the environmental apparatus of the battery electrolyte injection, the target voltage can be applied in a manner of a constant voltage or a pulsed voltage. As an optional implementation, when the environmental apparatus of the battery electrolyte injection is a battery circulation apparatus, the target voltage is applied in a pulsed manner; as another optional implementation, when the environmental apparatus of the battery electrolyte injection is a constant voltage apparatus, the target voltage is applied in a constant manner.

It should be noted that the above example is only an optional implementation. In practical applications, the application manner for the target voltage can be selected according to actual needs, and the embodiments of the present application are not limited to this.

In some embodiments, the battery system parameters of the battery may comprise the ambient temperature of the battery injection, the operating pressure, the battery structure, the electrode plate parameters, the electrolyte parameters, the separator, and the interaction parameters between the electrode plate or the separator and the electrolyte. Among them, the battery structure refers to the structural form of the wound battery core, such as the stacking structure and the wound structure; the electrode plate parameters refer to the positive and negative electrode plate materials of the battery, such as the positive electrode plate material is NCM523 in the ternary materials, and the negative electrode plate material is graphite material; the electrolyte parameter refers to the electrolyte solution composition, such as lithium ion electrolyte containing lithium hexafluorophosphate; the separator refers to the separator material used in the battery, such as PE separator; the interaction parameters between the electrode plate or separator and the electrolyte refer to the degree of interaction between the positive and negative electrode plates or separators of the battery and the electrolyte, such as specific adsorption, van der Waals force, electrostatic force, hydrogen bond, chemical bond, etc.

As an optional implementation, the battery system parameter of the battery may be a first battery system parameter, wherein the battery structure in the first battery system parameter is a wound-type battery, and the positive electrode plate in the electrode plate parameter is a ternary material of (NMC622) material.

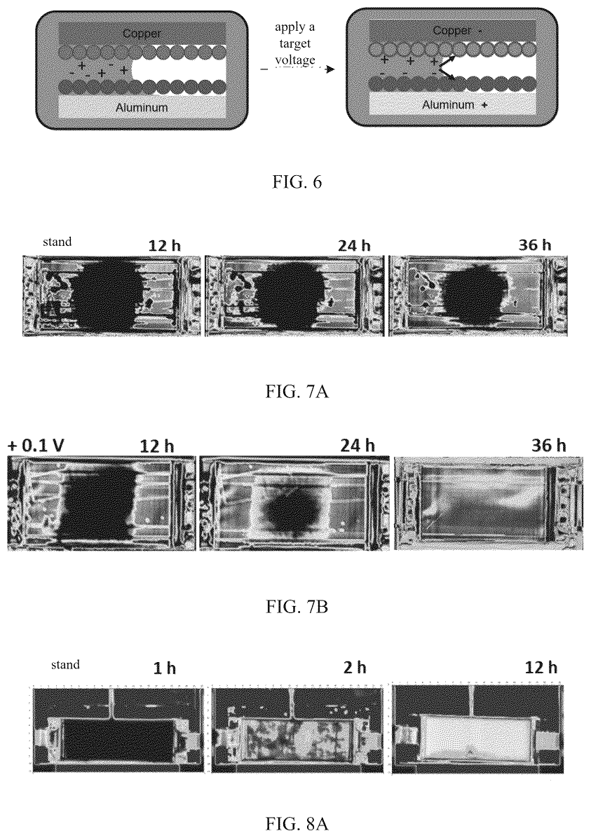

In a specific example, the first battery system parameter may specifically comprise: a wound-type battery, capacity 1 Ah, positive electrode NMC622, negative electrode graphite, separator PE, electrolyte composition: 1 M LiPF₆ (EC/DMC/EMC) (volume ratio 1:1:1), additive 1 wt % VC. FIG. 7A exemplarily shows a schematic view of the battery infiltration without voltage application, wherein, under the first battery system parameter, the target voltage is not applied to the battery, and the infiltration is achieved by static mode. As shown in FIG. 7A, the infiltration states of the battery after standing for 12 h (hours), 24 h (hours), and 36 h (hours) are shown respectively, and when the target voltage is not applied to the battery, the time taken for the electrolyte to infiltrate the battery electrode may be the first period. Corresponding to the battery infiltration time shown in FIG. 7A, FIG. 7B exemplarily shows a schematic view of the battery infiltration after voltage is applied, wherein the applied voltage is a target voltage of 0.1 V. As shown in FIG. 7B, the infiltration states of the battery after standing for 12 h, 24 h, and 36 h are respectively shown, and when the target voltage is applied to the battery, the time taken for the electrolyte to infiltrate the battery electrode plate may be the second period.

Combining FIG. 7A and FIG. 7B, it can be determined that the second period is less than the first period, that is, the time taken for the electrolyte to infiltrate the battery electrode plate when the target voltage is applied to the battery is less than the time taken for the electrolyte to infiltrate the battery electrode plate when the target voltage is not applied to the battery. It can be understood that the infiltration of the PE separator is poor. By applying the target voltage to the battery, the diffusion of the electrolyte between the electrodes is promoted, thereby improving the infiltration of the electrolyte.

As another optional implementation, the battery system parameter of the battery may be a second battery system parameter, wherein the battery structure in the second battery system parameter is a laminated battery, and the positive electrode plate in the electrode parameter is a lithium ferrous phosphate (LFP) material.

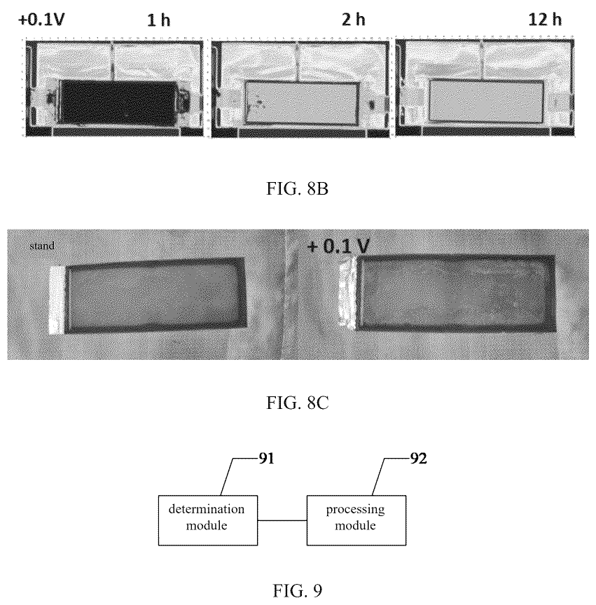

In a specific example, the second battery system parameter may specifically comprise: laminated battery, capacity 3.1 Ah, positive electrode LFP, negative electrode graphite, separator PE, electrolyte composition: 1 M LiPF₆ (EC/DMC/EMC) (volume ratio 1:1:1), additive 1 wt % VC. FIG. 8A exemplarily shows another schematic view of battery infiltration without voltage application, wherein, under the second battery system parameter, the target voltage is not applied to the battery, and the infiltration is achieved by static method. As shown in FIG. 8A, the infiltration states of the battery standing for 1 h (hour), 2 h (hour) and 12 h (hour) are shown respectively, and when the target voltage is not applied to the battery, the time taken for the electrolyte to infiltrate the battery electrode may be the third period. Corresponding to the battery infiltration time shown in FIG. 8A, FIG. 8B exemplarily shows another schematic view of the battery infiltration condition after applying a voltage, wherein the applied voltage is a target voltage of 0.1V. As shown in FIG. 8B, the infiltration state of the battery at 1 h (hour), 2 h (hour) and 12 h (hour) are respectively shown, and when the target voltage is applied to the battery, the time taken for the electrolyte to infiltrate the battery electrode plate may be the fourth period.

Combining FIG. 8A and FIG. 8B, it can be determined that the fourth period is less than the third period, that is, the time taken for the electrolyte to infiltrate the battery electrode plate when the target voltage is applied to the battery is less than the time taken for the electrolyte to infiltrate the battery electrode plate when the target voltage is not applied to the battery. Among them, the infiltration of the LFP electrode is poor. In order to further determine the effect of the target voltage on the infiltration of the electrolyte on the LFP electrode, FIG. 8C is a schematic view of the disassembly comparison of the electrode plate infiltration before and after the voltage is applied. As shown in FIG. 8C, after the target voltage is applied to the battery, the speed of the electrolyte infiltrating the LFP electrode is significantly increased. That is to say, by applying the target voltage, the diffusion of the electrolyte between the positive electrode (i.e., the LFP electrode) particles is enhanced, thereby promoting the improvement of the electrolyte infiltration speed and improving the infiltration of the electrolyte on the LFP electrode.

Further, based on FIG. 8B, corresponding to FIG. 7B, the fourth period is less than the second period, wherein the second period is the time taken for the electrolyte in the battery to infiltrate the battery electrode plate under the first battery system parameters when the target voltage is applied to the battery corresponding to the first battery system parameters. The battery structure in the first battery system parameters is a wound-type battery, and the positive electrode plate in the electrode plate parameters is Material NMC622; the first battery system parameters are the same as the second battery system parameters except for the battery structure and the electrode plate parameters. Combining FIG. 7B and FIG. 8B, it can be determined that, corresponding to different batteries, the battery system parameters of the batteries are different, and the infiltration characteristics are also different. Factors affecting the battery infiltration speed may be electrode materials, separators, electrolytes, etc.

The battery infiltration scheme provided in the embodiment of the present application determines the target voltage based on the battery system parameters when the battery system parameters of the battery are determined. The target voltage affects the infiltration performance of the electrolyte on the battery electrode plate, so that after the electrolyte is injected into the battery and before the battery electrode plate of the battery reacts with the electrolyte, a voltage application instruction corresponding to the target voltage is generated to apply the target voltage to the battery to improve the infiltration performance of the electrolyte on the battery electrode plate, so that the battery infiltration speed is improved, so that the battery infiltration speed can be improved more conveniently and quickly, avoiding the problems of cumbersome implementation processes and high equipment costs caused by using a high-temperature oven and pressurization and vacuum devices to improve the battery infiltration speed.

The battery infiltration apparatus provided in the embodiment of the present application is introduced below. The apparatus content described below may be regarded as a battery infiltration device or a computer device, which is a functional module required to implement the battery infiltration method provided in the embodiment of the present application. The apparatus content described below may be referred to in correspondence with the method content described above.

FIG. 9 shows an optional block diagram of the battery infiltration apparatus provided in the embodiment of the present application. As shown in FIG. 9, the apparatus may comprise:
a determination module 91, configured to determine a target voltage based on a battery system parameter of a battery, the target voltage affects the infiltration performance of an electrolyte on the battery electrode plate; wherein the target voltage is determined from a voltage application range corresponding to the battery system parameter, and the voltage application range is determined based on the battery system parameter of the battery;
a processing module 92, configured to generate a voltage application instruction corresponding to the target voltage after the electrolyte is injected into the battery and before the electrolyte reacts with the battery electrode plate; the voltage application instruction is used to apply the target voltage to the battery, so as to improve the infiltration performance of the electrolyte on the battery electrode plate.

In some embodiments, the battery comprises a first electrode and a second electrode; said generating a voltage application instruction corresponding to the target voltage comprises:
generating a voltage application instruction for applying the target voltage to the first electrode and the second electrode;
wherein, the first electrode carries a first charge after the target voltage is applied, and the second electrode carries a second charge after the target voltage is applied; the first ion is attracted by the first electrode with the first charge and moves to the first electrode; the second ion is attracted by the second electrode with the second charge and moves to the second electrode.

Optionally, the first electrode is a positive electrode and the second electrode is a negative electrode; the first charge is a negative charge and the second charge is a positive charge; the first ion is a cation and the second ion is an anion.

In some embodiments, the representation of the infiltration comprises a contact angle; the smaller the contact angle, the better the infiltration of the electrolyte to the battery electrode plate or separator.

In some embodiments, the determination module 91 is used to determine the target voltage based on the battery system parameters of the battery, comprising:

according to the relationship between the battery voltage corresponding to the battery system parameters and the battery infiltration degree, determining the voltage application range under the battery system parameters; selecting the target voltage according to the voltage application range; or
determining the voltage application range corresponding to the battery system parameter of the battery from a preset voltage application range set; selecting the target voltage from the determined voltage application range; the voltage application range set records the voltage application range corresponding to multiple battery system parameters, wherein the voltage application range under a battery system parameter is determined based on the relationship between the battery voltage corresponding to the battery system parameter and the battery infiltration degree.

Optionally, the voltage application range corresponding to the battery system parameter of the battery is 0 V to 2 V or −2 V to 0 V; the absolute value of the target voltage is 0.1 V.

Optionally, the target voltage is applied in a manner of a constant voltage or a pulsed voltage.

In some embodiments, the battery system parameters comprise: ambient temperature of battery electrolyte injection, operating pressure, battery structure, electrode plate parameters, electrolyte parameters, a separator, and interaction parameters between electrode plate or separator and electrolyte.

As an optional implementation, the battery system parameter is a first battery system parameter, the battery structure in the first battery system parameter is a wound-type battery, and the positive electrode plate in the electrode plate parameter is a ternary material of Material NMC622;
wherein, under the first battery system parameter, if the target voltage is not applied to the battery, the time taken for the electrolyte in the battery to infiltrate the battery electrode plate is the first period; if the target voltage is applied to the battery, the time taken for the electrolyte in the battery to infiltrate the battery electrode plate is the second period; the second period is less than the first period.

As another optional implementation, the battery system parameter is a second battery system parameter, the battery structure in the second battery system parameter is a laminated battery, and the positive electrode plate in the electrode plate parameter is a lithium ferrous phosphate LFP material;

Under the second battery system parameter, if the target voltage is not applied to the battery, the time taken for the electrolyte in the battery to infiltrate the battery electrode plate is the third period; if the target voltage is applied to the battery, the time taken for the electrolyte in the battery to infiltrate the battery electrode plate is the fourth period;
wherein, the fourth period is less than the third period, and the fourth period is less than the second period; the second period is the time taken for the electrolyte in the battery to infiltrate the battery electrode plate when the target voltage is applied to the battery corresponding to the first battery system parameter under the first battery system parameter, the battery structure in the first battery system parameter is a wound-type battery, and the positive electrode plate in the electrode plate parameter is Material NMC622; the first battery system parameter is the same as the second battery system parameter except for the battery structure and the electrode plate parameter.

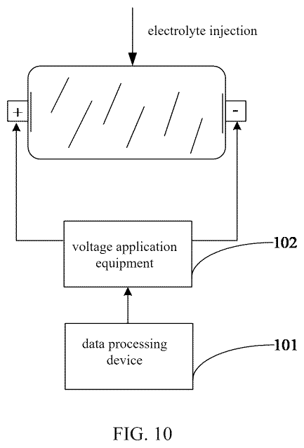

The embodiment of the present application also provides a battery infiltration system. FIG. 10 exemplarily shows an optional structural schematic diagram of the battery infiltration system of the embodiment of the present application. As shown in FIG. 10, the battery infiltration system may at least comprise a data processing device 101 and a voltage application equipment 102.

Among them, the data processing device 101 is used to determine a target voltage based on the battery system parameters of the battery, and the target voltage affects the infiltration performance of the electrolyte on the battery electrode plate; the target voltage is determined from the voltage application range corresponding to the battery system parameters, and the voltage application range is determined based on the battery system parameters of the battery; after the electrolyte is injected into the battery and before the battery electrode plate of the battery reacts with the electrolyte, a voltage application instruction corresponding to the target voltage is generated;

The voltage application equipment 102 is used to apply the target voltage to the battery under the control of the voltage application instruction to improve the infiltration performance of the electrolyte on the battery electrode plate.

The embodiment of the present application also provides a storage medium, and the storage medium stores one or more computer executable instructions, and the one or more computer executable instructions are used to execute the above-mentioned battery infiltration method.

The above describes multiple embodiments provided by the embodiments of the present application. The various optional methods introduced in the embodiments can be combined and cross-referenced with each other without conflict, thereby extending a variety of possible embodiments, which can all be considered as embodiments revealed and disclosed by the embodiments of the present application.

Although the embodiments of the present application are disclosed as above, the present application is not limited thereto. Any person skilled in the art can make various changes and modifications without departing from the spirit and scope of the present application. Therefore, the scope of protection of the present application shall be based on the scope defined by the claims.

1. A battery infiltration method, comprising:
determining a target voltage based on a battery system parameter of a battery, the target voltage affecting the infiltration performance of an electrolyte on the battery electrode plate, wherein the target voltage is determined from a voltage application range corresponding to the battery system parameter, and the voltage application range is determined based on the battery system parameter of the battery;
after the electrolyte is injected into the battery and before the electrolyte reacts with the battery electrode plate, generating a voltage application instruction corresponding to the target voltage, wherein the voltage application instruction is used to apply the target voltage to the battery, so as to improve the infiltration performance of the electrolyte on the battery electrode plate.

2. The battery infiltration method according to claim 1, wherein the battery comprises a first electrode and a second electrode; said generating a voltage application instruction corresponding to the target voltage comprises:
generating a voltage application instruction for applying the target voltage to the first electrode and the second electrode;
wherein the first electrode carries a first charge after the target voltage is applied, and the second electrode carries a second charge after the target voltage is applied; a first ion is attracted by the first electrode with the first charge and moves to the first electrode; a second ion is attracted by the second electrode with the second charge and moves to the second electrode.

3. The battery infiltration method according to claim 2, wherein the first electrode is a positive electrode, the second electrode is a negative electrode; the first charge is a negative charge, the second charge is a positive charge; the first ion is a cation, and the second ion is an anion.

4. The battery infiltration method according to claim 1, wherein the representation of the infiltration performance comprises a contact angle;
the smaller the contact angle, the better the infiltration of the electrolyte to the electrode plate or a separator of the battery.

5. The battery infiltration method according to claim 1, said determining the target voltage based on the battery system parameters of the battery, comprising:
determining the voltage application range under the battery system parameters according to the relationship between the battery voltage corresponding to the battery system parameters and the battery infiltration degree; selecting the target voltage according to the voltage application range; or
determining the voltage application range corresponding to the battery system parameters of the battery from a preset voltage application range set; selecting the target voltage from the determined voltage application range; the voltage application range set records the voltage application ranges corresponding to multiple battery system parameters, wherein the voltage application range under a battery system parameter is determined based on the relationship between the battery voltage corresponding to this battery system parameter and the battery infiltration degree.

6. The battery infiltration method according to claim 5, wherein the voltage application range corresponding to the battery system parameter of the battery is 0 V to 2 V or −2 V to 0 V; the absolute value of the target voltage is 0.1 V.

7. The battery infiltration method according to claim 6, wherein the target voltage is applied in a manner of a constant voltage or a pulsed voltage.

8. The battery infiltration method according to claim 1, wherein the battery system parameters comprise: ambient temperature of battery electrolyte injection, operating pressure, a battery structure, an electrode plate parameter, an electrolyte parameter, a separator, and an interaction parameter between an electrode plate or a separator and the electrolyte.

9. The battery infiltration method according to claim 8, wherein the battery system parameters are first battery system parameters, the battery structure in the first battery system parameters is a wound-type battery, and the positive electrode plate in the electrode plate parameters is a ternary material of Material NMC622;
wherein, under the first battery system parameters, if the target voltage is not applied to the battery, the time taken for the electrolyte to infiltrate the battery electrode plate in the battery is a first period; if the target voltage is applied to the battery, the time taken for the electrolyte to infiltrate the battery electrode plate in the battery is a second period; the second period is less than the first period.

10. The battery infiltration method according to claim 8, wherein the battery system parameters are second battery system parameters, the battery structure in the second battery system parameters is a laminated battery, and the positive electrode plate in the electrode plate parameters is a LFP material of lithium ferrous phosphate;
under the second battery system parameter, if the target voltage is not applied to the battery, the time taken for the electrolyte to infiltrate the battery electrode plate in the battery is a third period; if the target voltage is applied to the battery, the time taken for the electrolyte to infiltrate the battery electrode plate in the battery is a fourth period;
wherein the fourth period is less than the third period, and the fourth period is less than the second period; the second period is the time taken for the electrolyte to infiltrate the battery electrode plate in the battery when the target voltage is applied to the battery corresponding to the first battery system parameters under the first battery system parameters, the battery structure in the first battery system parameters is a wound-type battery, and the positive electrode plate in the electrode plate parameters is Material NMC622; other parameters of the first battery system parameters are the same as those of the second battery system parameters except for the battery structure and the electrode plate parameters.

11. A battery infiltration apparatus, comprising:
a determination module, configured to determine a target voltage based on a battery system parameter of a battery, the target voltage affecting the infiltration performance of an electrolyte on the battery electrode plate; wherein the target voltage is determined from a voltage application range corresponding to the battery system parameter, and the voltage application range is determined based on the battery system parameter of the battery;
a processing module, configured to generate a voltage application instruction corresponding to the target voltage after the electrolyte is injected into the battery and before the electrolyte reacts with the battery electrode plate; the voltage application instruction is used to apply the target voltage to the battery, so as to improve the infiltration performance of the electrolyte on the battery electrode plate.

12. A battery infiltration system, at least comprising a data processing device and a voltage application equipment;
wherein the data processing device is used to determine a target voltage based on a battery system parameter of a battery, the target voltage affecting the infiltration performance of an electrolyte on the battery electrode plate; wherein the target voltage is determined from a voltage application range corresponding to the battery system parameter, and the voltage application range is determined based on the battery system parameter of the battery; after the electrolyte is injected into the battery and before the battery electrode plate of the battery reacts with the electrolyte, a voltage application instruction corresponding to the target voltage is generated;
the voltage application equipment is used to apply the target voltage to the battery under the control of the voltage application instruction, so as to improve the infiltration performance of the electrolyte on the battery electrode plate.

13. A storage medium, storing one or more computer executable instructions, wherein the one or more computer executable instructions are used to execute the battery infiltration method according to claim 1.
